(19) United States
(12) Patent Application Publication
(10) Pub. No.: US 2019/0045025 A1
(43) Pub. Date: Feb. 7, 2019

(54) Distributed Recognition Feedback Acquisition System

(71) Applicant: Walmart Apollo, LLC, Bentonville, AR (US)

(72) Inventors: Steven Jackson Lewis, Bentonville, AR (US); Suman Pattnaik, Bentonville, AR (US); Matthew Dwain Biermann, Fayetteville, AR (US)

(21) Appl. No.: 16/054,034

(22) Filed: Aug. 3, 2018

Related U.S. Application Data
(60) Provisional application No. 62/541,377, filed on Aug. 4, 2017.

(51) Int. Cl. H04L 29/08; H04W 4/35; H04W 4/80; H04M 1/725

(52) U.S. Cl. CPC H04L 67/306; H04M 1/7253; H04W 4/80; H04W 4/35

(57) ABSTRACT

Systems and methods for dynamic recognition feedback acquisition are discussed. A recognition feedback acquisition system acquires information from the short-range communication device of associated with an individual by reading the short-range communication device and generates recognition information regarding the individual that includes the acquired tag information. The recognition feedback acquisition system further assigns a value to the received recognition information, aggregates the assigned value for the individual to update a recognition status, and transmits data regarding the updated recognition status to a device associated with the individual.

### RELATED APPLICATION

This application claims the benefit of, and priority to, U.S. Provisional Patent Application No. 62/541,377, filed Aug. 4, 2017.

### BACKGROUND

Today's mobile computing devices, such as smartphones, are frequently equipped with a number of different short-range communication devices. For example, many smartphones are equipped with Near-Field Communication (NFC) readers or Radio-Frequency Identification (RFID) readers, such that the mobile devices can acquire data from another short-range communication device, such as an NFC tag or RFID tag when the smartphone equipped with the reader is brought within communication range of the NFC or RFID tag. The data acquired by the mobile devices may be sent to remote locations for further processing.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a block diagram showing a recognition feedback acquisition system in accordance with an exemplary embodiment.

FIG. 2 is a flow diagram illustrating a method performed by a recognition feedback acquisition system in accordance with an exemplary embodiment.

FIG. 3 is a flow diagram illustrating a method performed by a recognition feedback acquisition system in accordance with another exemplary embodiment.

FIG. 4 is a flow diagram illustrating an example sequence for responding to a user's request regarding an object category performed by the recognition feedback acquisition system in accordance with an exemplary embodiment.

FIG. 5 is a flow diagram illustrating an example sequence for analyzing recognition information performed by the recognition feedback acquisition system in accordance with an exemplary embodiment.

FIG. 6 is a block diagram of an exemplary computational device with various components which can be used to implement various embodiments.

FIG. 7 is block diagram of an exemplary distributed system suitable for use in exemplary embodiments.

### DETAILED DESCRIPTION

Methods and systems are described herein for providing recognition feedback to individuals via a mobile application integrated into a distributed recognition feedback acquisition system. Among other features, the recognition feedback acquisition system, in accordance with various embodiments, is configured to acquire RFID or NFC tag information of an associate in a facility via a mobile application using the RFID or NFC reader on a mobile device, generate recognition information for the facility associate with the mobile application and pass the recognition information from the mobile device to a computing system in communication with the mobile device. The computing system assigns a value to the received recognition information, and aggregates the assigned value for the facility associate with previous stored values for the associate. The aggregated value is associated with the facility associate and an indication of the current status of the value is transmitted to a device associated with the facility associate thereby providing dynamic recognition feedback to the associate.

In one non-limiting example, a customer equipped with a smart phone executing the mobile application may interact with a facility associate and be pleased with the interaction. The customer may “bump” the associate's nametag or vest which is equipped with an NFC tag, RFID tag or other short-range communication device with their smartphone to use their smartphone's reader to acquire the associate's identity data (“bumping” refers to the act of actually touching the short-range communication device with the smartphone holding the reader. It will be appreciated that actual contact is not necessary as long as the reader is within range to read the device). In one embodiment, the associate may be asked to opt-in to being part of the recognition feedback system given the closeness of the customer during the bumping process. The mobile application may then include the associate's identity data as part of the recognition information sent to a central server, optionally accompanied by scanned product information and additional comments entered via a user interface generated by the mobile application. It should be appreciated that the “identity” may be a numeric ID that is matched by the server to the actual associate data so that no identifying data that could be used by the customer traverses the customer's smartphone. The recognition information for the associate may be aggregated with previously stored information associated with the facility associate. An updated status reflective of the recognition information may then be returned to a device associated with the facility associate. For example, the indication of the updated status may be returned to a mobile device operated by the associate or may be returned to a device worn by the associate. In one embodiment, the transmitted indication may cause a status light on a vest or name badge worn by the associate to be illuminated in a color reflective of the new status. In another embodiment, the updated status could be transmitted to a customer service board in the facility that includes facility associate rankings.

In one embodiment, if the recognition information is generated by co-workers or relatives of the facility associate, the system can assign a particular value to the received recognition information, and if the recognition information is generated by other users, the system can assign another greater value to the received recognition information. Similarly, in another embodiment, to prevent abuse of the recognition information, such as constant self-bumping, or bumping between friends, the recognition information can be determined as invalid if the amount of recognition information from a particular user account is greater than a threshold value during a particular time period.

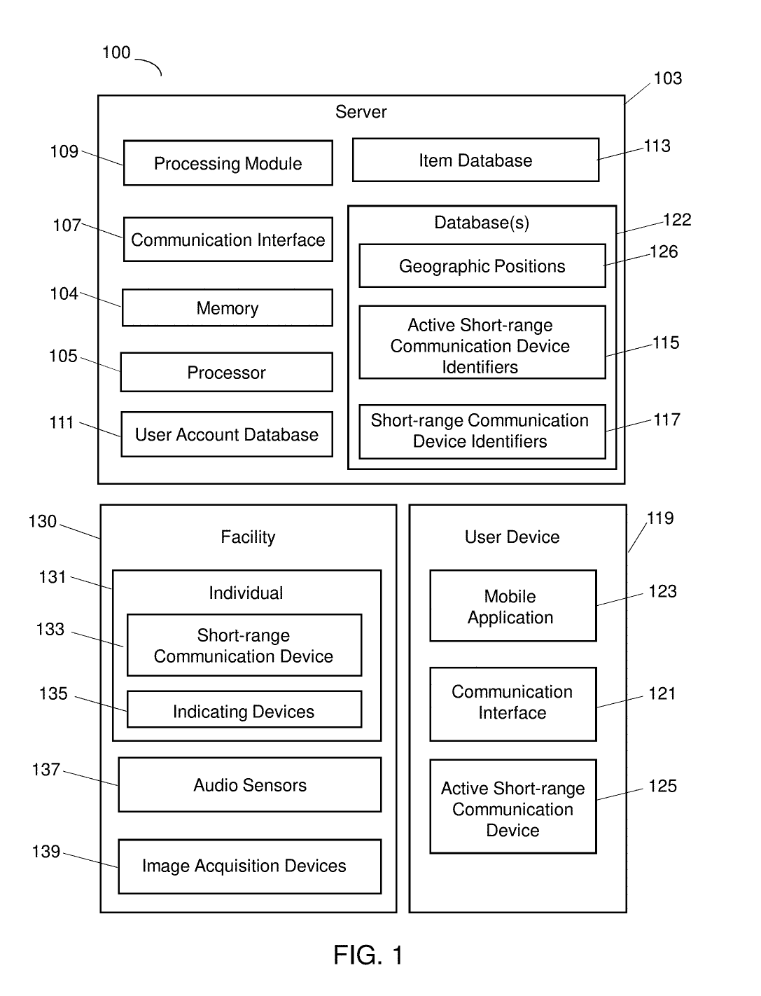

Referring now to FIG. 1, a distributed image-based acquisition system 100 in an exemplary embodiment includes a server 103. The server 103 includes memory 104, a processor 105 and communication interface 107. The server is configured to execute a processing module 109 and also includes or is able to access a user account database 111, item database 113, and database(s) 122 including information regarding active short-range communication device identifiers (e.g. NFC or RFID readers) 115, short-range communication device identifiers (e.g. NFC or RFID tags) 117, and geographic positions 126.

The processing module 109, which may include one or more computing-device executable processes, makes use of the communications interface 107 to receive transmitted recognition information data for an individual 131, for example, a facility associate, from a mobile application 123 executing on a mobile user device 119. The processing module 109 is configured to analyze the received recognition information, updates recognition status, and transmit data regarding the updated recognition status to indicating devices 135 associated with the individual 131. As noted above, the indicating devices 135 may be an LED on a badge or vest being worn by the individual 131, a display screen in the facility 130 or a mobile device associated with the individual. The user account database 111 includes information associated with each user account for individuals registered as operating the mobile application, such as an email address, whether the individual is a co-worker of the individual 131, and whether the user is related to the individual, for example, a friend or a relative of the individual 131, etc. The item database 113 includes information regarding items available for sale in the facility or online.

Communication interface 107 may be used by server 103 to communicate with user device 119 and, in accordance with various embodiments can include, but is not limited to, a radio frequency (RF) receiver, RF transceiver, NFC device, a built-in network adapter, network interface card, PCMCIA network card, card bus network adapter, wireless network adapter, USB network adapter, modem or any other communication mechanism suitable for interfacing with any type of network capable of communication and performing the operations described herein. Processor 105, in accordance with various embodiments can include, for example, but not limited to, a microchip, a processor, a microprocessor, a special purpose processor, an application specific integrated circuit, a microcontroller, a field programmable gate array, any other suitable processor, or combinations thereof. Server 103 may also include, memory (not shown) such as but not limited to, hardware memory, non-transitory tangible media, magnetic storage disks, optical disks, flash drives, computational device memory, random access memory, such as but not limited to DRAM, SRAM, EDO RAM, any other type of memory, or combinations thereof.

User device 119 includes communication interface 121 for communicating with the server 103 and executes a mobile application 123. User device 119 may be smartphone, tablet or other mobile device equipped with a processor, mobile application 123 and communication interface 121. The mobile application 123 can generate a user interface for accepting user input and is configured to control an integrated data acquisition device such as, but not limited to, an active short-range communication device 125, such as a NFC or RFID reader, to acquire NFC/RFID tag information, and, in one embodiment, a camera on user device to capture images of items.

In one embodiment user device 119 may include a device suitable for acquiring and/or transmitting machine-readable identifier data, including for example, a low power blue-tooth device, a barcode scanners, a barcode reader, a digital camera, a mobile device, a magnetic strip reader, a point of sale terminal, any other suitable device, or combinations thereof. For example, as part of the recognition feedback process, the user may scan a barcode of a product that was related to the interaction of the user with the facility associate and the scanned information may be transmitted as part of the recognition information along with the facility associated identifier to the server 103. The processing module 109 may use the object information to further classify the facility associate feedback by relating it to particular product categories. Further, the category information may be aggregated and the associate's ranked based on object category.

Mobile application 123 transmits the recognition information including any captured images or scanned data via communication interface 121 to processing module 109 on server 103.

Processing module 109 analyzes the recognition information to extract short-range communication device identifiers, such as the NFC/RFID tag identifier. The extracted data is used to query user account database 111, short-range communication device identifiers 117 to determine its associated individual. Processing module 109 may also analyze received images to extract item information. The item information can be associated with the received recognition information.

Processing module 109 can update the recognition status of the individual 131, and then transmit the data regarding the updated recognition status to indicating devices 135 associated with the individual 131, such as a smart vest or badge with LED indicators, a customer service board in the facility with rankings, or a mobile device associated with the facility associate.

In a facility 130 such as a retail location, each individual 131, such as a facility associate, is associated with a short-range communication device 133, such as a NFC or RFID tag. The facility 130 may also include audio sensors 137 and image acquisition deices 139 to execute a voice and face recognition module as described further herein.

The active short-range communication device 125, such as an NFC/RFID reader, can be configured to read short-range communication device 133, such as an NFC tag or RFID tag, within range of active short-range communication device. When a short-range communication device 133 is within the range of an active short-range communication device 125, the short-range communication device can receive a radio-frequency (RF) signal from the active short-range communication device and the short-range communication device can respond with a radio-frequency (RF) signal. The RF response signal from the short-range communication device 133 can include a unique identifier associated with the short-range communication device and/or data stored in memory of the short-range communication device. For example, in exemplary embodiments, NFC/RFID tags can be affixed to the facility associate 131, and the RF response signal from each of the NFC/RFID tags can include a unique short-range communication device identifier 117 and data associated with the facility associate to which the NFC/RFID tag is affixed. The unique short-range communication device identifier 117 can be, for example, an alphanumeric string, that allows the system to differentiate between different individuals 131. The unique short-range communication device identifiers 117 can be electronically stored in one or more databases of the system 100. Each active short-range communication device 125 can also have an active short-range communication unique identifier 115 (e.g., an alphanumeric value or string) associated with each user account to allow for differentiation between the short-range communication device within the facility 130 and for identification of the geographic position of each NFC/RFID reader 125 within the facility 130. The active short-range communication unique identifier 115 can be electronically stored in one or more databases of the system 100.

The RF signal response transmitted from the short-range communication device 133 and received by the active short-range communication device 125 can be used to identify geographic positions of the facility associate 131 and the user associated with the user device 119 within the facility. The geographic position information 126 can include information regarding the type of department, the aisle, and the fixture related to the location of the facility associate 131 and the user. The geographic position information 126 can be stored in one or more databases of the system 100.

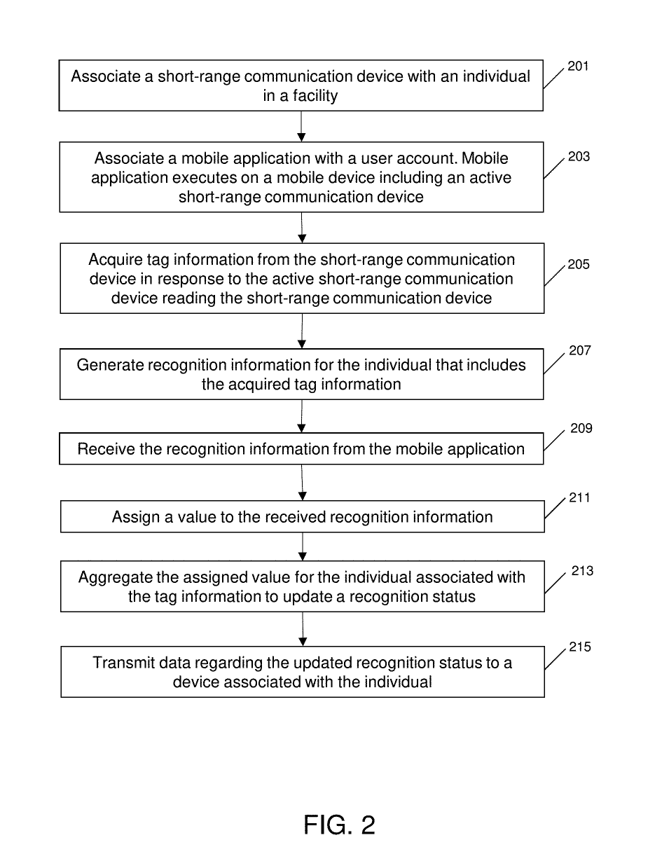

FIG. 2 is a flow diagram illustrating a sequence of steps performed by a recognition feedback acquisition system in accordance with an exemplary embodiment that provides recognition feedback to individuals. At step 201, a processing module on a computing system associated with a retail entity respectively associates each of a group of short-range communication devices, such as NFC or RFID tags, with an individual in the facility, such as facility associates. At step 203, the processing module associates a mobile application with a user account. The mobile application executes on a mobile device being operated by the user (associated with the user account) and includes an active short-range communication device, such as a NFC or RFID reader.

At step 205 when a facility associate provides a good service to a user, the user can use the active short-range communication device on the user's smartphone to read the short-range communication device associated with the facility associate, and acquire information. The information can include identification information for the facility associate. At step 207, the mobile application generates recognition information that includes the identification information and can further include additional comments entered by the user of the mobile device via a user interface provided by the mobile application. As discussed further below, the recognition information may further include product information related to an object scanned by the user that is related to the interaction with the facility associate.

At step 209, the processing module receives the recognition information transmitted from the mobile application, and assigns a value to the recognition information at step 211. For example, the processing module can assign a specified numerical value to positive feedback from the user. At step 213, the assigned value can be aggregated to previously stored feedback values to update a recognition status of the facility associate. In a non-limiting example, the numerical value may be added to a previously stored total and divided by the total number of times that recognition information has been received for the individual to calculate an average rating reflecting the new status. In one embodiment, the system can update the ranking of all the facility associates in real-time according to the received feedback. Then at step 215, the data regarding the updated recognition status can be transmitted to indicating devices associated with the facility associates. For example, based on the updated ranking, a customer service board in the facility can be updated accordingly, or LED indicators associated with a smart vest of the facility associate ranked first can be switched to a color different from other facility associates. Alternatively, the LED indicators associated with the facility associate can display a different color according to the received data regarding the updated recognition status. In this manner, the system can provide dynamic feedback to the facility associate for providing good service to the users in the facility.

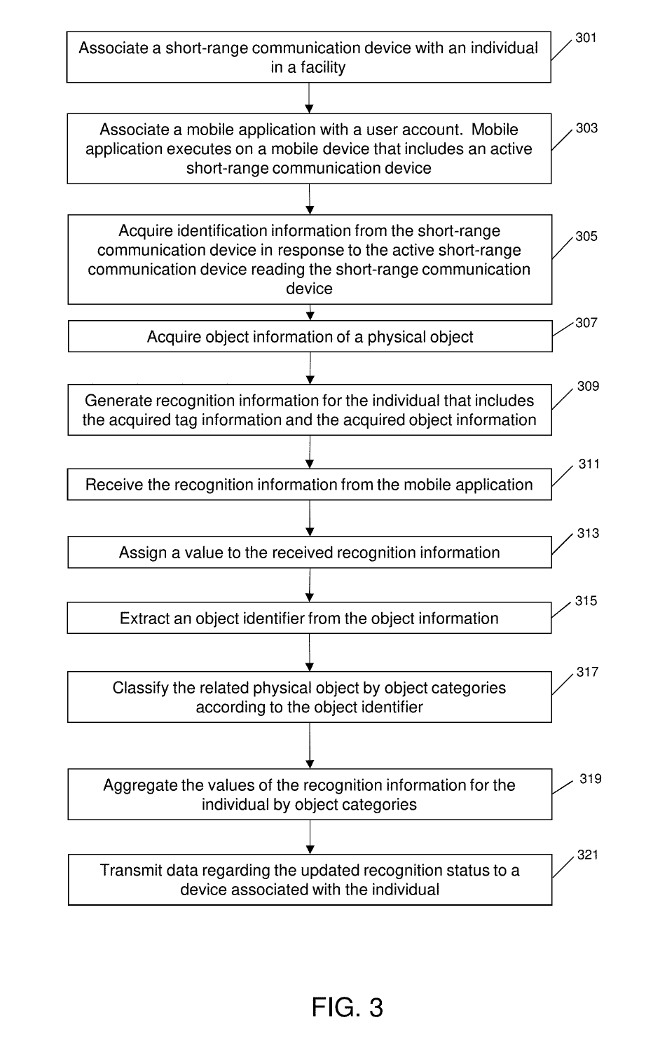

FIG. 3 is a flow diagram illustrating a sequence of steps performed by a recognition feedback acquisition system in accordance with an exemplary embodiment that provides recognition feedback based on item categories. At step 301, a processing module on a computing system of a retail entity associates the short-range communication devices with the facility associates. At step 303, the processing module associates a mobile application with a user account. The mobile application executes on a mobile device including the NFC or RFID reader.

At step 305, in one embodiment, when a facility associate provides a good customer service to a user regarding a physical object of a particular item category in the facility, the user can use the active short-range communication device on the user's smartphone or other mobile device to read the short-range communication device associated with the facility associate to acquire information. At step 307, the user can acquire related item information using the mobile device, for example, using a camera on the mobile device to capture images of items, or using a barcode reader to capture barcode information of the item. At step 309, the mobile application generates recognition information that includes the read identification information and the item information acquired by the user of the mobile device via the mobile application.

At step 311, the processing module receives the recognition information transmitted from the mobile application, and assigns a value to the recognition information at step 313. Then the processing module extracts the item identifier from the received item information at step 315, and classifies the related physical object by item categories according to the item identifier at step 317. For example, if the related object is an electronic product, such as a television, the related object is classified in the consumer electronics category.

At step 319, the assigned values of the recognition information can be aggregated based on different item categories, and the recognition status of the related item category can be updated. For example, the assigned value related to the electronic product can be aggregated to the value related to the consumer electronics category. Then at step 321, the data regarding the updated recognition status can be transmitted to a device associated with the facility associate.

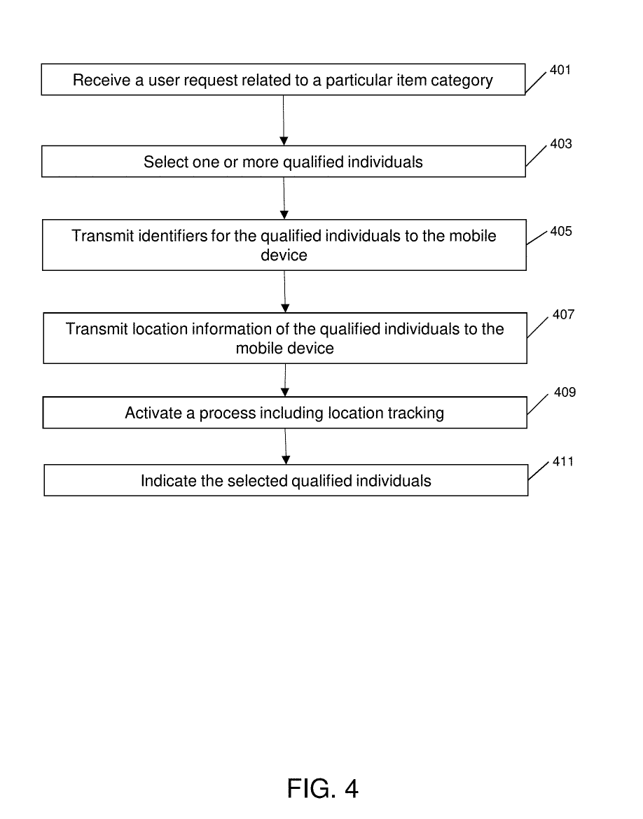

In one embodiment, the system can select a qualified facility associate based on the received recognition information and the updated recognition status according to a user's request for help regarding a particular item category. FIG. 4 is a flow diagram illustrating a sequence of steps performed by a recognition feedback acquisition system in accordance with an exemplary embodiment that responds to a user's request regarding a particular item category. At step 401, the system receives a user request via the mobile application indicating that the user associated with the mobile device needs help from a facility associate who is highly rated in assisting with a particular item category. At step 403, the system can select one or more qualified facility associates based on the ranking in the corresponding item category. For example, if the user requests a facility associate who is highly rated with respect to electronic products, such as televisions, the system can select the facility associate ranked first in the consumer electronic category.

At step 405, the system can transmit identifiers for the qualified individuals to the mobile device, and at step 407, the system can also transmit location information of the qualified individuals to the mobile device based on the system's current information regarding the individual's location. At step 409, the system can activate a location tracking process on the user's mobile device to locate the selected facility associate based on the location information of the user and the selected facility associate. Also, at step 411 the system can inform the selected facility associate that he/she is requested by a user. Further, in one embodiment the system can also activate a location tracking process on a device of the selected facility associate, such as a beacon whose signal can be detected by the user's mobile device, to assist the user in t locating the selected facility associate. In this manner, the system can select the qualified facility associate based on the recognition information, or the recognition information in a particular item category.

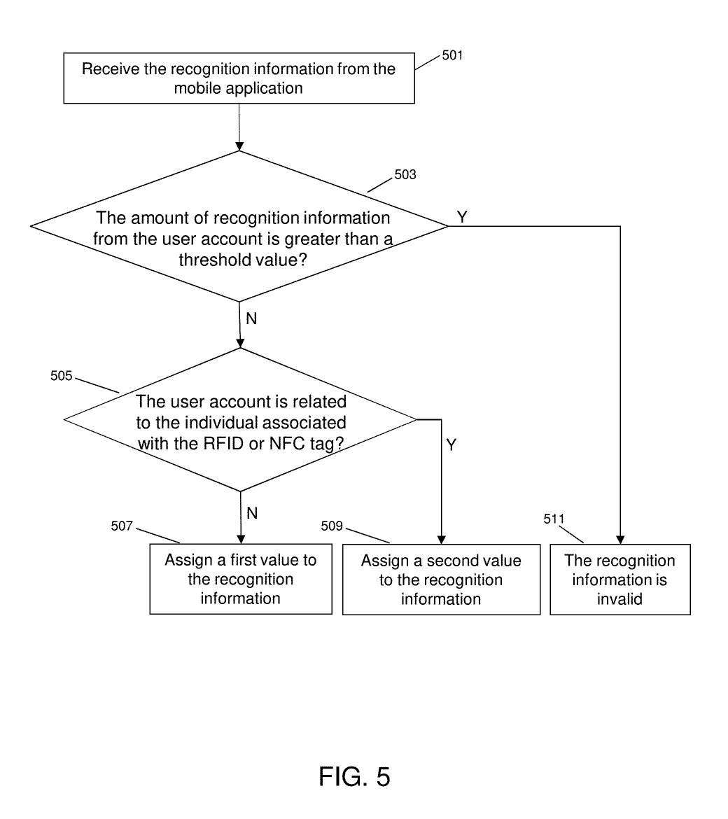

FIG. 5 is a flow diagram illustrating a sequence of steps performed by a recognition feedback acquisition system in accordance with an exemplary embodiment that analyzes recognition information to prevent unauthorized inflation of recognition status by family or co-workers. At step 501, the system receives the recognition information for a particular facility associate from the mobile application associated with a user account. At step 503, the system determines whether the amount of recognition information from the same user account is greater than a predetermined threshold value during a predetermined time period. If it is, at step 511, the received recognition information is determined as invalid and the information is ignored.

If the amount of recognition information from the same user account is determined not to be greater than the threshold, at step 505, the system further determines whether the user account generating the recognition information is related with the facility associate based on a profile of the facility associate. For example, the system determines whether the user account is associated with co-workers of the facility associate, or the user account is associated with relatives of the facility associate. If not, the recognition information is assigned with a first value at step 507. Otherwise, if the recognition information is from a user related to the facility associate or a co-worker, the recognition information is assigned with a second lesser value at step 509. For example, the recognition feedback generated by a co-worker or relative of the facility associate may be assigned a numerical value that is a set fraction of the value assigned to feedback from other users. In this manner, the system can prevent abuse of the recognition information, such as constant self-bumping, or bumping between friends.

In another embodiment, the system can execute a voice and face recognition module utilizing audio sensors and image acquisition devices disposed in the facility. The system can analyze the voice and face data of a user received from the audio sensors and image acquisition devices when the facility associate is providing service to the user, assign values to the voice and face data according to the analyzing result, and aggregate the assigned value from the voice and face data to update the recognition status of the facility associate.

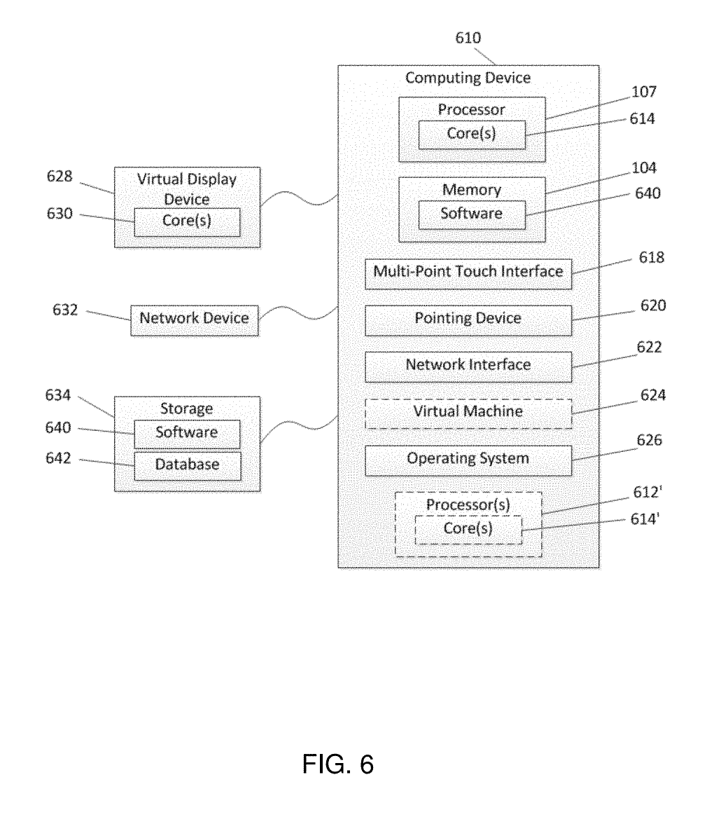

FIG. 6 is a block diagram of an exemplary computing device 610 such as can be used, or portions thereof, in accordance with various embodiments and, for clarity, refers back to and provides greater detail regarding various elements of the system 100 of FIG. 1. The computing device 610, which can be, but is not limited to the server, user mobile device and data capture devices described herein, can include one or more non-transitory computer-readable media for storing one or more computer-executable instructions or software for implementing exemplary embodiments. The non-transitory computer-readable media can include, but is not limited to, one or more types of hardware memory, non-transitory tangible media (for example, one or more magnetic storage disks, one or more optical disks, one or more flash drives), and the like. For example, memory 104 included in the computing device 610 can store computer-readable and computer-executable instructions or software for performing the operations disclosed herein. For example, the memory 104 can store a software application 640 which is configured to perform the disclosed operations (e.g., provide recognition feedback to individuals in facilities). The computing device 610 can also include configurable and/or programmable processor 107 and an associated core 614, and optionally, one or more additional configurable and/or programmable processing devices, e.g., processor(s) 612′ and associated core(s) 614′ (for example, in the case of computational devices having multiple processors/cores), for executing computer-readable and computer-executable instructions or software stored in the memory 104 and other programs for controlling system hardware. Processor 107 and processor(s) 612′ can each be a single core processor or multiple core (614 and 614′) processor.

Virtualization can be employed in the computing device 610 so that infrastructure and resources in the computing device can be shared dynamically. A virtual machine 624 can be provided to handle a process running on multiple processors so that the process appears to be using only one computing resource rather than multiple computing resources. Multiple virtual machines can also be used with one processor.

Memory 104 can include a computational device memory or random access memory, such as DRAM, SRAM, EDO RAM, and the like. Memory 104 can include other types of memory as well, or combinations thereof.

A user can interact with the computing device 610 through a visual display device 628, such as any suitable device capable of rendering texts, graphics, and/or images including an LCD display, a plasma display, projected image (e.g. from a Pico projector), Google Glass, Oculus Rift, HoloLens, and the like, and which can display one or more user interfaces 630 that can be provided in accordance with exemplary embodiments. The computing device 610 can include other I/O devices for receiving input from a user, for example, a keyboard or any suitable multi-point touch (or gesture) interface 618, a pointing device 620 (e.g., a mouse). The keyboard 618 and the pointing device 620 can be coupled to the visual display device 628. The computing device 610 can include other suitable conventional I/O peripherals.

The computing device 610 can also include one or more storage devices 634, such as a hard-drive, CD-ROM, flash drive, or other computer readable media, for storing data and computer-readable instructions and/or software that perform operations disclosed herein. In some embodiments, the one or more storage devices 634 can be detachably coupled to the computing device 610. Exemplary storage device 634 can also store one or more software applications 640 for implementing processes of the recognition feedback processing system described herein and can include databases 642 for storing any suitable information required to implement exemplary embodiments. The databases can be updated manually or automatically at any suitable time to add, delete, and/or update one or more items in the databases. In some embodiments, at least one of the storage device 634 can be remote from the computing device (e.g., accessible through a communication network) and can be, for example, part of a cloud-based storage solution.

The computing device 610 can include a network interface 622 configured to interface via one or more network devices 632 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 622 can include a built-in network adapter, network interface card, PCMCIA network card, card bus network adapter, wireless network adapter, USB network adapter, modem or any other device suitable for interfacing the computing device 610 to any type of network capable of communication and performing the operations described herein. Moreover, the computing device 610 can be any computational device, such as a workstation, desktop computer, server, laptop, handheld computer, tablet computer, or other form of computing or telecommunications device that is capable of communication and that has sufficient processor power and memory capacity to perform the operations described herein.

The computing device 610 can run operating systems 626, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or other operating systems capable of running on the computing device and performing the operations described herein. In exemplary embodiments, the operating system 626 can be run in native mode or emulated mode. In an exemplary embodiment, the operating system 626 can be run on one or more cloud machine instances.

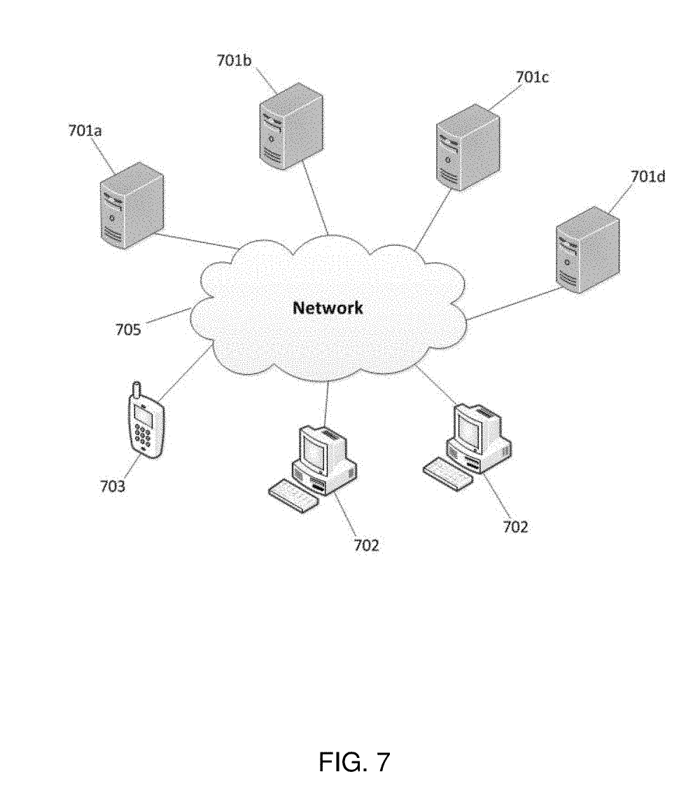

FIG. 7 is a block diagram of exemplary distributed and/or cloud-based embodiments. Although FIG. 1, and portions of the exemplary discussion above, make reference to a centralized recognition feedback processing system 100 operating on a single computing device, one will recognize that various of the modules within the recognition feedback processing system 100 may instead be distributed across a network 706 in separate server systems 701a-d and possibly in user systems, such as a desktop computer device 702, or mobile computer device 703. As another example, the user interface provided by the mobile application 123 can be a client side application of a client-server environment (e.g., a web browser or downloadable application, such as a mobile app), wherein the processing module 109 is hosted by one or more of the server systems 701a-d (e.g., in a cloud-based environment) and interacted with by the desktop computer device or mobile computer device. In some distributed systems, the modules of the system 100 can be separately located on server systems 701a-d and can be in communication with one another across the network 706.

Portions or all of the embodiments of the present invention may be provided as one or more computer-readable programs or code embodied on or in one or more non-transitory mediums. The mediums may be, but are not limited to a hard disk, a compact disc, a digital versatile disc, a flash memory, a PROM, a RAM, a ROM, or a magnetic tape. In general, the computer-readable programs or code may be implemented in many computing languages.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A distributed system for providing recognition feedback to a plurality of individuals, the system comprising:
a plurality of short-range communication devices each associated with one of a plurality of individuals in a facility;
a mobile application associated with a user account and executable on a mobile device including an active short-range communication device, the mobile application when executed:
acquiring with the active short-range communication device information transmitted from one of the plurality of short-range communication devices associated with one of the plurality of individuals following the active short-range communication device being brought within communication range of the one of the plurality of short-range communication devices by a user of the mobile device, and
generating recognition information for the one of the plurality of individuals that includes the acquired tag information; and
a computing system in communication with the mobile device, the computing system configured to execute a recognition module that when executed:
receives the recognition information transmitted from the mobile application;
assigns a value to the received recognition information;
aggregates the assigned value for the one of the plurality of individuals associated with the tag information to update a recognition status; and
transmits data regarding the updated recognition status to a device associated with the one of the plurality of individuals.

2. The system of claim 1 wherein the recognition information includes additional comments regarding the one of the plurality of individuals entered by the user of the mobile device via the mobile application.

3. The system of claim 1,
wherein the information includes identification information for the one of the plurality of individuals.

4. The system of claim 1, wherein the mobile application when executed:
acquires object information of a physical object, and
transmits the object information to the recognition module as part of the recognition information.

5. The system of claim 4, wherein the recognition module when executed:
extracts an object identifier from the object information transmitted from the mobile device;
classifies the related physical object by object categories according to the object identifier; and
aggregates the values of the recognition information for the one of the plurality of individuals by object categories.

6. The system of claim 1, wherein the recognition module when executed:
assigns a first value to the recognition information received from a first group of user accounts; and
assigns a second value to the recognition information received from a second group of user accounts representing at least one of co-workers and relatives of the one of the plurality of individuals, the second value less than the first value.

7. The system of claim 6, wherein the recognition information is determined as invalid when the amount of recognition information from a particular user account is greater than a predetermined threshold value during a predetermined time period.

8. The system of claim 1, wherein the recognition module when executed:
determines whether a user account is related with the individual associated with the short-range communication device based on a profile of the associated individual.

9. The system of claim 1, wherein the recognition module when executed
selects one or more qualified individuals based on a user requirement of the aggregated values of a particular object category related with the plurality of individuals; and
transmits identifiers for the qualified individuals to the mobile device.

10. The system of claim 9, wherein the recognition module when executed:
transmits location information of the qualified individuals to the mobile device.

11. The system of claim 1, wherein the recognition module when executed:
updates an appearance of an indicator associated with each of the plurality of individual according to their respective recognition status.

12. A computer-implemented method for providing recognition feedback to a plurality of individuals, comprising:
associating a plurality of short-range communication devices with one of a plurality of individuals in a facility;
associating a mobile application with a user account and executing the mobile application on a mobile device including an active short-range communication device,
acquiring with the active short-range communication device information transmitted from one of the plurality of short-range communication devices associated with one of the plurality of individuals following the active short-range communication device being brought within communication range of the one of the plurality of short-range communication devices by a user of the mobile device,
generating recognition information for the one of the plurality of individuals that includes the acquired tag information; and
receiving the recognition information transmitted from the mobile application;
assigning a value to the received recognition information;
aggregating the assigned value for the one of the plurality of individuals associated with the tag information to update a recognition status; and
transmitting data regarding the updated recognition status to a device associated with one of the plurality of individuals.

13. The method of claim 12,
wherein the recognition information includes additional comments regarding the one of the plurality of individuals entered by the user of the mobile device via the mobile application.

14. The method of claim 12,
wherein the information includes identification information for the one of the plurality of individuals.

15. The method of claim 12, further comprising:
acquiring object information of a physical object, and
transmitting the object information as part of the recognition information.

16. The method of claim 15, further comprising:
extracting an object identifier from the object information transmitted from the mobile device;
classifying the related physical object by object categories according to the object identifier; and
aggregating the values of the recognition information for the one of the plurality of individuals by object categories.

17. The method of claim 12, further comprising:
assigning a first value to the recognition information received from a first group of user accounts; and
assigning a second value to the recognition information received from a second group of user accounts representing at least one of co-workers and relatives of the one of the plurality of individuals, the second value less than the first value.

18. The method of claim 17, wherein the recognition information is determined as invalid when
the amount of recognition information from a particular user account is greater than a predetermined threshold value during a predetermined time period.

19. The method of claim 12, further comprising:
selecting one or more qualified individuals based on a user requirement of the aggregated values of a particular object category related with the plurality of individuals; and
transmitting identifiers for the qualified individuals to the mobile device.

20. The method of claim 19, further comprising:
transmitting location information of the qualified individuals to the mobile device.
